(19) United States
(12) Patent Application Publication
(10) Pub. No.: US 2014/0262276 A1
(43) Pub. Date: Sep. 18, 2014

(54) VISCOSITY ENHANCEMENT OF POLYSACCHARIDE FLUIDS

(71) Applicant: SCHLUMBERGER TECHNOLOGY CORPORATION, SUGAR LAND, TX (US)

(72) Inventors: LEIMING LI, SUGAR LAND, TX (US); BLAKE MCMAHON, SUGAR LAND, TX (US); LIJUN LIN, SUGAR LAND, TX (US)

(73) Assignee: SCHLUMBERGER TECHNOLOGY CORPORATION, SUGAR LAND, TX (US)

(21) Appl. No.: 14/200,977

(22) Filed: Mar. 7, 2014

Related U.S. Application Data
(60) Provisional application No. 61/779,859, filed on Mar. 13, 2013.

(51) Int. Cl. C09K 8/68

(52) U.S. Cl. CPC C09K 8/685
USPC 166/300

(57) ABSTRACT

A method of treating a subterranean formation includes providing a treatment composition comprising at least one hydroxyl carboxylic acid, a crosslinkable component and a crosslinking agent. The treatment composition is then introduced to the subterranean formation, such that the combination of the hydroxyl carboxylic acid, a crosslinkable component and a crosslinking agent in the treatment composition increases the viscosity of the well treatment composition.

### CROSS-REFERENCE TO RELATED APPLICATION

This application claims the benefit of U.S. Provisional Application Ser. No. 61/779,859 filed Mar. 13, 2013 entitled “Viscosity Enhancement of Polysaccharide Fluids” to Li et al. (Attorney Docket No. IS12.3009-US-PSP), the disclosure of which is incorporated by reference herein in its entirety.

### BACKGROUND

Hydrocarbons (oil, natural gas, etc.) are obtained from a subterranean geologic formation (a “reservoir”) by drilling a well that penetrates the hydrocarbon-bearing formation. In the process of recovering hydrocarbons from subterranean formations, it is common practice to treat a hydrocarbon-bearing formation with a pressurized fluid to provide flow channels, i.e., to fracture the formation, or to use such fluids to control sand to facilitate flow of the hydrocarbons to the wellbore.

Well treatment fluids, particularly those used in fracturing, typically comprise water- or oil-based fluid incorporating a thickening agent, normally a polymeric material. Typical polymeric thickening agents for use in such fluids comprise galactomannan gums, such as guar and substituted guars such as hydroxypropyl guar (HPG) and carboxymethylhydroxypropyl guar (CMHPG). Cellulosic polymers such as hydroxyethyl cellulose or carboxymethyl cellulose (CMC) may also be used, as well as synthetic polymers such as polyacrylamide. Sometimes guar is modified with ionic groups to facilitate hydration of the polymer and to improve crosslinking with metal complexes. Ionic modification of the polymers can reduce the time it takes to dissolve the dry polymer at the well site, and improve both the ultimate gel strength and the thermal persistence of the gel upon crosslinking with a metal crosslinking complex.

In order to prevent the resulting fracture from closing upon release of fluid pressure, typically a hard particulate material known as a proppant, may be dispersed in the well treatment fluid to be carried into the resulting fracture and deposited therein. The well treatment fluid should possess a fairly high viscosity, such as, a gel-like consistency, at least when it is within the fracture so that the proppant can be carried as far as possible into the resulting fracture. Moreover, it would be desirable that the well treatment fluid exhibit a relatively low viscosity as it is being pumped down the wellbore, and in addition exhibit a relatively high viscosity when it is within the fracture itself The viscosity of well treatment fluids may be enhanced by crosslinking with boron and/or a metal such as chromium aluminum, hafnium, antimony, or a Group 4 metal such as zirconium or titanium.

To increase the viscosity, and, therefore, the proppant carrying ability of the fluid, as well as increase its high temperature stability, crosslinking of the polymeric materials may be employed. Crosslinking a polymer solution may increase the steady shear viscosity up to two orders of magnitude. For well stimulation treatments, particularly hydraulic fracturing, this is important for a number of reasons, including creating fracture width and transporting proppant.

By necessity, well treatment fluids are prepared on the surface, and then pumped through tubing in the wellbore to the hydrocarbon-bearing subterranean formation. While high viscosity, thickened fluid is highly desirable within the formation in order to transfer hydraulic pressure efficiently to the rock and to reduce fluid leak-off, large amounts of energy are required to pump such fluids through the tubing into the formation. To reduce the amount of energy required, various methods of delaying crosslinking have been developed. These techniques allow the pumping of a relatively less viscous fluid having relatively low friction pressures within the well tubing with crosslinking being affected near or in the formation so that the advantageous properties of thickened crosslinked fluid are available at the rock face.

During the process of obtaining hydrocarbons (including the acts described above), undesirable materials, such as water, may also travel through the formation in the vicinity of the wellbore and ultimately enter the wellbore. The presence of water may be an issue in numerous formations, including but sand, sandstone, chalk, limestone and other similar formations. The rate at which the water appears in the wellbore may be slowed through the use of various technologies directed to preventing undesirable materials from entering the wellbore. Conventional water shut off techniques range from mechanical to chemical treatment strategies.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The statements made merely provide information relating to the present disclosure, and may describe some embodiments illustrating the subject matter of this application.

In a first aspect, a method for treating a subterranean formation penetrated by a wellbore is disclosed. The method includes providing a treatment composition comprising at least one hydroxyl carboxylic acid, a crosslinkable component and a crosslinking agent, and introducing the treatment composition to the subterranean formation, wherein the combination of the hydroxyl carboxylic acid, a crosslinkable component and a crosslinking agent increases the viscosity of the well treatment composition.

In a second aspect, a method for treating a subterranean formation penetrated by a wellbore is disclosed. The method includes a method of treating a subterranean formation, the method comprising: providing a treatment composition comprising at least one hydroxyl carboxylic acid, a crosslinkable component and a crosslinking agent; and introducing the treatment composition to the subterranean formation, wherein the combination of the hydroxyl carboxylic acid, a crosslinkable component and a crosslinking agent increases the viscosity of the well treatment composition of from about 100% to about 500% when compared to a baseline viscosity.

### BRIEF DESCRIPTION OF DRAWINGS

The manner in which the objectives of the present disclosure and other desirable characteristics may be obtained is explained in the following description and attached drawings in which:

FIG. 1 shows a graphical representation of a rheological plot according to one or more embodiments described herein.

FIG. 2 shows a graphical representation of a rheological plot according to one or more embodiments described herein.

FIG. 3 shows a graphical representation of a rheological plot according to one or more embodiments described herein.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The statements made herein merely provide information related to the present disclosure and may not constitute prior art.

The present application relates to methods and compositions for treating subterranean formations. More particularly, the present application relates to treatment fluids comprising hydroxyl carboxylic acid, and methods of using these in treatment fluids in high-temperature fracturing operations.

Treatment fluids may be used in a variety of subterranean treatments, including, but not limited to, stimulation treatments and sand control treatments. As used herein, the term “treatment,” or “treating,” refers to any subterranean operation that uses a fluid in conjunction with a desired function and/or for a desired purpose. The term “treatment,” or “treating,” does not imply any particular action by the fluid or any particular component thereof. For example, a treatment fluid placed or introduced into a subterranean formation may be, for example, a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a driller fluid, a frac-packing fluid, or gravel packing fluid.

The term “subterranean formation” refers to any physical formation that lies at least partially under the surface of the earth.

A “wellbore” may be any type of well, including, a producing well, a non-producing well, an injection well, a fluid disposal well, an experimental well, an exploratory deep well, and the like. Wellbores may be vertical, horizontal, deviated some angle between vertical and horizontal, and combinations thereof, for example a vertical well with a non-vertical component.

Metal-crosslinked polymer fluids can be shear-sensitive after they are crosslinked. In particular, exposure to high shear typically occurs within the tubulars during pumping from the surface to reservoir depth, and can cause an undesired loss of fluid viscosity and resulting problems such as screenout. As used herein, the term “high shear” refers to a shear rate of 500/second or more. The high-shear viscosity loss in metal-crosslinked polymer fluids that can occur during transit down the wellbore to the formation is generally irreversible and cannot be recovered.

Organic acids, such as hydroxyl carboxylic acids have been employed as crosslinking delay agents for various oilfield operations. These processes are described in detail in U.S. Pat. Nos. 4,609,479, 4,861,500, 5,021,171 and 4,749,041, the disclosure of which are incorporated by reference herein in their entirety. Typically, increasing the amount of the organic acid increased the effect of the crosslinking delay agents. However, the addition of specific amounts of an organic acid may delay crosslinking and also enhance the viscosity. The enhanced viscosity may be from about 100% to about 1000% when compared to the baseline viscosity, such as, for example, from about 100% to about 500% of the baseline viscosity, and from about 100% to about 300% the baseline viscosity.

This increase in viscosity may vary depending on the conditions of the reservoir and the surface equipment such that the increase in the amount of viscosity may occur in the surface equipment, the wellbore, the near wellbore region, the perforation or the fracture. Further, an increase in viscosity may be desirable as such an increase allows for the suspension of solid particulate material, such as proppant.

### Hydroxyl Carboxylic Acid

In embodiments, described herein are a composition and/or method of treating a subterranean formation with a composition containing a hydroxyl carboxylic acid to increase the viscosity of the fluid. Examples of hydroxyl carboxylic acid include α-hydroxy carboxylic acids, β-hydroxy carboxylic acids and γ-hydroxy carboxylic acids.

α-hydroxy carboxylic acids (also known as α-hydroxy acids, alpha hydroxy acids, or AHAs) are a class of chemical compounds having a hydrocarbon backbone, a carboxylic acid end group and at least one hydroxyl group substituted on the carbon atom adjacent to the carboxylic acid end group. The carbon atoms of the hydrocarbon backbone (not substituted with the hydroxyl groups) may be substituted with one or more alkyl, alkyoxy or aromatic groups. Examples of α-hydroxy carboxylic acids include monocarboxylic acids, such as, for example, lactic acid and glycolic acid (also referred to as “glycolic acid”); dicarboxylic acids, such as malic acid; or tricarboxylic acids, such as citric acid. Moreover, α-hydroxy carboxylic acids can be polyhydroxypolycarboxylic acids such as tartaric acid or saccharic acid, monocarboxylic acids having a plurality of hydroxy groups, such as gluconic acid and glyceric acid, or aromatic hydroxy acids such as mandolin acid.

A β-hydroxy acid is an organic compound that contains a one or more carboxylic acid functional groups and one or more hydroxyl functional groups, the carboxylic acid functional group(s) separated from the hydroxyl functional group by two (2) carbon atoms. The carbon atoms of the hydrocarbon backbone (not substituted with the hydroxyl groups) may be substituted with one or more alkyl, alkyoxy or aromatic groups. Specific examples of β-hydroxy carboxylic acids include salicylic acid, β-hydroxypropionic acid, β-hydroxybutyric acid, β-hydroxy β-methylbutyrate, carnitine, and other organic compounds that contain a carboxylic acid functional group and hydroxy functional group separated by two carbon atoms.

A γ-hydroxy carboxylic acids is an organic compound that contains one or more carboxylic acid functional groups and one of more hydroxyl functional groups, the carboxylic acid functional group(s) separated from the hydroxyl functional group by three (3) carbon atoms. The carbon atoms of the hydrocarbon backbone (not substituted with the hydroxyl groups) may be substituted with one or more alkyl, alkyoxy or aromatic groups. Specific examples of γ-hydroxy carboxylic acids include 4-hydroxybutanoic acid and 4-hydroxyvaleric acid, and other organic compounds that contain a carboxylic acid functional group and hydroxy functional group separated by three carbon atoms.

As discussed above, the amount of the hydroxyl carboxylic acid may affect the increase in viscosity. The amount of the hydroxyl carboxylic acid may be from about 0.05 gpt to about 1 gpt, from about 0.05 gpt to about 0.75 gpt, from about 0.05 gpt to about 0.5 gpt, from about 0.1 gpt to about 0.5 gpt and from about 0.1 gpt to about 0.2 gpt. Although not listed explicitly, as discussed above, all values within the above ranges are disclosed.

### Crosslinkable Component

The treatment fluids or compositions suitable for use in the methods of the present disclosure comprise a crosslinkable component. As discussed above, a “crosslinkable component,” as the term is used herein, is a compound and/or substance that comprises a crosslinkable moiety. For example, the crosslinkable components may contain one or more crosslinkable moieties, such as a carboxylate and/or a cis-hydroxyl (vicinal hydroxyl) moiety, which is able to coordinate with the reactive sites of the crosslinker. The reactive sites of the crosslinker may be, for example, the site where the metals (such as Al, Zr and Ti and/or other Group IV metals) are present. The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2-methyl-propane sulfonic acid, acrylic acid, acrylamide, or derivative thereof and combinations thereof.

In embodiments, the crosslinkable components may present at about 0.01% to about 4.0% by weight based on the total weight of the treatment fluid, such as at about 0.10% to about 2.0% by weight based on the total weight of the treatment fluid.

The term “derivative” herein refers, for example, to compounds that are derived from another compound and maintain the same general structure as the compound from which they are derived.

The treatment fluid of the present disclosure may be a solution initially having a very low viscosity that can be readily pumped or otherwise handled. For example, the viscosity of the fluid may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature, such as from about 4° C. to about 80° C., or from about 10° C. to about 70° C., or from about 25° C. to about 60° C., or from about 32° C. to about 55° C.

Crosslinking the fluid of the present disclosure generally increases its viscosity. As such, having the composition in the uncrosslinked/unviscosified state allows for pumping of a relatively less viscous fluid having relatively low friction pressures within the well tubing, and the crosslinking may be delayed in a controllable manner such that the properties of thickened crosslinked fluid are available at the rock face instead of within the wellbore. Such a transition to a crosslinked/uncrosslinked state may be achieved over a period of minutes or hours based on the particular molecular make-up of the crosslinker, and results in the initial viscosity of the treatment fluid increasing by at least an order of magnitude, such as at least two orders of magnitude.

Suitable solvents for use with the fluid in the present disclosure may be aqueous or organic based. Aqueous solvents may include at least one of fresh water, sea water, brine, mixtures of water and water-soluble organic compounds and mixtures thereof. Organic solvents may include any organic solvent with is able to dissolve or suspend the various components of the treatment fluid, such as, for example, organic alcohols, such as, isopropanol.

In some embodiments, the treatment fluid may initially have a viscosity similar to that of the aqueous solvent, such as water. An initial water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The rate at which the viscosity of the treatment fluid changes may be varied by the choice of the crosslinker and polymer employed in the treatment fluid. The viscosity of the treatment fluid may also be varied by increasing or decreasing the amount of solvent relative to other components, or by other techniques, such as by employing viscosifying agents. In embodiments, the solvent, such as an aqueous solvent, may represent up to about 99.9 weight percent of the treatment fluid, such as in the range of from about 85 to about 99.9 weight percent of the treatment fluid, or from about 98 to about 99.7 weight percent of the treatment fluid.

In some embodiments, the treatment fluid may contain chelating agents to “sequester” scale-forming metal ions such as Ca²⁺, Mg²⁺, and Fe³⁺.

### Crosslinking Agent

The crosslinking agent in the treatment fluids of the present disclosure may comprise a polyvalent metal ion that is capable of crosslinking at least two molecules of the crosslinkable component. Examples of suitable metal ions include, but are not limited to, zirconium IV, titanium or aluminum and/or other Group IV metals, or combinations thereof. Other suitable crosslinkers can contain boron. The metal ions may be provided by providing any compound that is capable of producing one or more of these ions. Examples of such compounds include zirconyl chloride, zirconium sulfate and triethanol titanate.

In some embodiments, the crosslinking agent is present in the treatment fluid in an amount from about 0.1 to about 1.0% by volume. In some embodiments, the crosslinking agent comprises about 0.3% by volume of the fluid. Considerations one may take into account in deciding how much crosslinking agent may be needed include the temperature conditions of a particular application, the composition of the gelling agent used, and/or the pH of the treatment fluid. Other considerations may be evident to one skilled in the art.

The crosslinking agent may also comprise a stabilizing agent operable to provide sufficient stability to allow the crosslinking agent to be uniformly mixed into the polymer solution. Examples of suitable stabilizing agents include, but are not limited, to propionate, acetate, formate, triethanolamine, and triisopropanolamine. Additional stabilizing agents are discussed below.

The treatment fluid should not begin to build viscosity before it is placed into the desired portion of a subterranean formation. If it builds viscosity too quickly, this would interfere with pumping and placement of the crosslinkable polymer composition into the formation.

While the treatment fluids of the present disclosure are described herein as comprising the above-mentioned components, it should be understood that the fluids of the present disclosure may optionally comprise other chemically different materials. In embodiments, the fluid may further comprise stabilizing agents, surfactants, diverting agents, or other additives. Additionally, the treatment fluid may comprise a mixture various other crosslinking agents, and/or other additives, such as fibers or fillers, provided that the other components chosen for the mixture are compatible with the intended use of forming a crosslinked three dimensional structure that at least partially seals a portion of a subterranean formation, such as a water bearing portion of a subterranean formation, permeated by the treatment fluid or treatment fluid. In embodiments, the treatment fluid of the present disclosure may further comprise one or more components such as, for example, a gel breaker, a buffer, a proppant, a clay stabilizer, a gel stabilizer, and a bactericide. Furthermore, the treatment fluid or treatment fluid may include buffers, pH control agents, and various other additives added to promote the stability or the functionality of the fluid. The treatment fluid or treatment fluid may be based on an aqueous or non-aqueous solution. The components of the treatment fluid or treatment fluid may be selected such that they may or may not react with the subterranean formation that is to be sealed.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the formation of a three dimensional structure upon substantial completion of the crosslinking reaction. For example, the fluid or treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure after its formation downhole. Typical stabilizing agents include buffering agents, such as agents capable of buffering at pH of about 8.0 or greater (such as water-soluble bicarbonate salts, such as sodium bicarbonate, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the crosslinker.

Buffering agents may be added to the treatment fluid in an amount from about 0.05 wt. % to about 10 wt. %, and from about 0.1 wt. % to about 2 wt. %, based upon the total weight of the treatment fluid. Additional chelating agents may be added to the fluid or treatment fluid to at least about 0.75 mole per mole of metal ions expected to be encountered in the downhole environment, such as at least about 0.9 mole per mole of metal ions, based upon the total weight of the fluid or treatment fluid.

Surfactants can be added to promote dispersion or emulsification of components of the fluid, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. No. 6,703,352, U.S. Pat. No. 6,239,183, U.S. Pat. No. 6,506,710, U.S. Pat. No. 7,303,018 and U.S. Pat. No. 6,482,866, each of which are incorporated by reference herein in their entirety, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944(available from Baker Petrolite of Sugar Land, Tex.). A surfactant may be added to the fluid in an amount in the range of about 0.01 wt. % to about 10 wt. %, such as about 0.1 wt. % to about 2 wt. % based upon total weight of the treatment fluid.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

The treatment fluids described herein may also include one or more inorganic salts. Examples of these salts include water-soluble potassium, sodium, and ammonium salts, such as potassium chloride, ammonium chloride or tetramethyl ammonium chloride (TMAC). Additionally, sodium chloride, calcium chloride, potassium chloride, sodium bromide, calcium bromide, potassium bromide, sodium sulfate, calcium sulfate, sodium phosphate, calcium phosphate, sodium nitrate, calcium nitrate, cesium chloride, cesium sulfate, cesium phosphate, cesium nitrate, cesium bromide, potassium sulfate, potassium phosphate, potassium nitrate salts may also be used. Any mixtures of the inorganic salts may be used as well. The inorganic salt may be added to the fluid in an amount of from about 0.01 wt. % to about 80 wt. %, from about 0.1 wt. % to about 20 wt. %, from about 0.1 wt. % to about 10 wt. %, based upon total weight of the treatment fluid.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing or even eliminating the use of conventional fluid loss additives. Latex resins or polymer emulsions may be incorporated as fluid loss additives. Shear recovery agents may also be used in embodiments.

The above fluids may also comprise a breaker. The purpose of this component is to “break” or diminish the viscosity of the fluid so that this fluid is more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc.

The concentration of proppant in the fluid can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the fluids to achieve a variety of properties including improving particle suspension, and particle transport capabilities, and gas phase stability. Fibers used may be hydrophilic or hydrophobic in nature. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use fluids containing other additives and chemicals that are known to be commonly used in oilfield applications by those skilled in the art. These include, but are not necessarily limited to, materials such as surfactants in addition to those mentioned hereinabove, breaker aids in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

As used herein, the term “alcohol stabilizer” is used in reference to a certain group of organic molecules substantially or completely soluble in water containing at least one hydroxyl group, which are susceptible of providing thermal stability and long term shelf life stability to aqueous zirconium complexes. Examples of organic molecules referred as “alcohol stabilizers” include but are not limited to methanol, ethanol, n-propanol, isopropanol, n-butanol, tert-butanol, ethyleneglycol monomethyl ether, and the like.

Methods of the present disclosure may be used to seal or reduce the flow of an unacceptable amount of water (or other undesired material) into or near the wellbore. The phrase unacceptable amount of water (or other undesired material) may be determined on a case-by-case basis. As used herein, the terms “seal,” “sealed” and “sealing” mean at least the ability to substantially prevent fluids, such as fluids comprising an unacceptable amount of water, to flow through the area where the crosslinkable components of the fluid were crosslinked. The terms “seal,” “sealed” and “sealing” may also mean the ability to substantially prevent fluids from flowing between the medium where the crosslinkable components of the fluid were crosslinked and whatever surface it is sealing against, for example an open hole, a sand face, a casing pipe, and the like.

After at least a portion of the treatment fluid has permeated the subterranean formation, such as water-bearing subterranean formation, the methods of the present disclosure may comprise crosslinking the crosslinkable components of the fluid to form a three dimensional crosslinked structure and seal the subterranean formation. As discussed above, a subterranean formation is sealed if part or a majority of subterranean formation has been treated with the treatment fluid and the crosslinkable components of the treatment fluid in this treated zone have been crosslinked in a sufficient amount such that the permeability of the subterranean formation is reduced. For example, upon formation of a three dimensional crosslinked structure as a result of crosslinking the crosslinkable components of the treatment fluid of the present disclosure, the permeability of the subterranean formation may decrease by at least about 80%, such as by at least about 90%, or by at least about 99%. In embodiments, for a predetermined vertical region (depending on the vertical depth of the region to be sealed), the sealed zone may be a volume extending at least about 15 cm from the outer wall of the wellbore, such as a volume extending at least about 30 cm from the outer wall of the wellbore, or a volume extending at least about 50 cm from the outer wall of the wellbore.

In the methods of the present disclosure, crosslinking may be accomplished by exposing the treatment fluid to heat and/or electromagnetic radiation to generate a thermal reaction. In embodiments, the crosslinking may be substantially completed, such as about 75% of the crosslinker is reacted, or about 95% of the crosslinker is reacted, or about 99.9% of the crosslinker is reacted, in a time no less than about 0.5 hours, or in a time no less than about one day, such as a time no less than about two weeks.

In some embodiments, the crosslinking temperature may be set such that a permanent crosslink, such as a crosslinked material formed from a crosslinker comprising Zr or Ti, is completed in the lower portion of the wellbore or after exiting the perforations into the fracture. This will minimize the damage done by high shear experienced during tubular transit. For example, the crosslinking temperature may be set at a temperature in the range of from 5° C. to about 40° C., such as a temperature in the range of from 10° C. to about 30° C.

The fluids of the present disclosure may be suitable for use in numerous subterranean formation types. For example, formations for which sealing with the fluids of the present disclosure may be used include sand, sandstone, shale, chalk, limestone, and any other hydrocarbon bearing formation.

The portion of the wellbore through which the fluid is injected into the treated zone can be open-hole (or comprise no casing) or can have previously received a casing. If cased, the casing is desirably perforated prior to injection of the fluid. Optionally, the wellbore can have previously received a screen. If it has received a screen, the wellbore can also have previously received a gravel pack, with the placing of the gravel pack optionally occurring above the formation fracture pressure (a frac-pack).

Techniques for injection of fluids with viscosities similar to those of the treatment fluids of the present disclosure are well known in the art and may be employed with the methods of the present disclosure. For example, known techniques may be used in the methods of the present disclosure to convey the fluids of the present disclosure into the subterranean formation to be treated.

In embodiments, the fluid may be driven into a wellbore by a pumping system that pumps one or more fluids into the wellbore. The pumping systems may include mixing or combining devices, wherein various components, such as fluids, solids, and/or gases maybe mixed or combined prior to being pumped into the wellbore. The mixing or combining device may be controlled in a number of ways, including, but not limited to, using data obtained either downhole from the wellbore, surface data, or some combination thereof. Methods of this disclosure may include using a surface data acquisition and/or analysis system, such as described in U.S. Pat. No. 6,498,988, incorporated herein by reference in its entirety. In embodiments, one or more fluid is pumped into the wellbore after detecting an unacceptable amount of water or other condition has been detected. Specific embodiments may comprise sealing the zone of interest (which may be where an unacceptable amount of water or other condition has been detected) using the fluid optionally with packers, such as straddle cup packers. Packers or similar devices can be used to control flow of the fluid into the subterranean formation for which sealing is desired.

In embodiments, the fluid may be injected into the subterranean formation at a pressure less than the fracturing pressure of the formation. For example, the fluids will be injected below the formation fracturing pressure of the respective formation.

The volume of fluids to be injected into subterranean formation is a function of the subterranean formation volume to be treated and the ability of the fluid of the present disclosure to penetrate the subterranean formation. The volume of fluid to be injected can be readily determined by one of ordinary skill in the art. As a guideline, the formation volume to be treated relates to the height of the desired treated zone and the desired depth of penetration. In embodiments, the depth of penetration of the fluid may be at least about 15 cm from the outer wall of the wellbore into the subterranean formation, such as the depth of penetration of at least about 30 cm from the outer wall of the wellbore.

The ability of the fluid to penetrate the subterranean formation depends on the permeability of the subterranean formation and the viscosity of the fluid. In embodiments, the viscosity of the fluid is sufficiently low as to not slow penetration of the consolidating fluid into the subterranean formation. In a low-permeability subterranean formation, the viscosity of the fluid is sufficiently low as to not slow penetration of the consolidating fluid into the subterranean formation. For example, in a low-permeability subterranean formation, suitable initial viscosities may be similar to that of water, such as from about from about 1 cP to about 10,000 cP, or be from about 1 cP to about 1,000 cP, or be from about 1 cP to about 100 cP at the treating temperature, which may range from a surface temperature to a bottom-hole static (reservoir) temperature, such as from about 4° C. to about 80° C., or from about 10° C. to about 70° C., or from about 25° C. to about 60° C., or from about 32° C. to about 55° C.

In embodiments, after the fluid penetrates the subterranean formation, the crosslinking reaction occurs, whereby the one or more the components of the fluid, including the crosslinker are crosslinked. The crosslinked structure formed may comprise three-dimensional linkages that effectively blocks permeation of fluids through the sealed region. Thus, the sealed subterranean formation becomes relatively impermeable and any remaining pores in the sealed subterranean formation do not communicate with the wellbore and do not produce water.

After the subterranean formation has been sealed according to the methods of the present disclosure, it may be rendered relatively impermeable. In embodiments, the permeability of the subterranean formation may be reduced by at least about 90%, such as by at least about 95%, or by at least about 99%. In embodiments, fracturing or perforating through the sealed subterranean formation may be performed to allow communication through the sealed subterranean formation.

The fluids and/or methods may be used for hydraulically fracturing a subterranean formation. Techniques for hydraulically fracturing a subterranean formation are known to persons of ordinary skill in the art, and involve pumping a fracturing fluid into the borehole and out into the surrounding formation. The fluid pressure is above the minimum in situ rock stress, thus creating or extending fractures in the formation.

In various embodiments, hydraulic fracturing involves pumping a proppant-free viscous fluid, or pad—such as water with some fluid additives to generate high viscosity—into a well faster than the fluid can escape into the formation so that the pressure rises and the rock breaks, creating artificial fractures and/or enlarging existing fractures. Then, proppant particles are added to the fluid to form slurry that is pumped into the fracture to prevent it from closing when the pumping pressure is released. In the fracturing treatment, fluids of are used in the pad treatment, the proppant stage, or both.

Specific embodiments of the present disclosure will now be described in detail with reference to the accompanying drawings. Further, in the following detailed description of embodiments of the present disclosure, numerous specific details are set forth in order to provide a more thorough understanding of the present application. However, it will be apparent to one of ordinary skill in the art that the embodiments disclosed herein may be practiced without these specific details. In other instances, well-known features have not been described in detail to avoid unnecessarily complicating the description.

### EXAMPLES

### Example 1

### Glycolic Acid

0.2 gpt (0.02% by volume) of a mixture of glutaraldehyde and water (1:3 ratio) was added to tap water. Next, 30 pounds per thousand gallons (ppt) (0.36 wt. %) of guar was then hydrated in the water. During the hydration, the fluid pH was controlled to be 6-8 using acetic acid. Once the hydration was completed, 0.5 gpt of a 50/50 mixture of TMAC (tetramethyl ammonium chloride) and water, 1 gallons per thousand gallons (gpt) of a surfactant, and 6 ppt of sodium bicarbonate were added while blending. A crosslinker solution was prepared by blending 0.6 gpt (relative to the whole volume of the fluid) of a mixture of 20% isopropanol and 80% triethanolamine titanate, 1.8 gpt (relative to the whole volume of the fluid) of a mixture of acetic acid, isopropanol and water, and five (5) different amounts of glycolic acid (70% solution) ranging from 0 gpt, 0.1 gpt, 0.15 gpt, 0.2 gpt and 1 gpt (relative to the whole volume of the fluid). The crosslinker was added as the last additive to the fluid. This resulted in the formation of five different fluids.

The viscosity (at a shear rate of 100/s) at 145° F. (63° C.) of the five (5) titanate-crosslinked gel fluids was measured with a Fann50-type viscometer. The viscosities for these fluids are shown in FIG. 1.

As shown in FIG. 1, compared with the baseline fluid (having 0 gpt glycolic acid), the fluids with 0.15 gpt and 0.2 gpt of glycolic acid (70%) showed an enhanced (over about 100%) viscosity as compared to the other fluids. However, the present inventors understand that the viscosity enhancing effect of the glycolic acid depends on a number of factors including, but not limited to, the fluid formula (such as polymer loading, and fluid chemical types and doses) and the test conditions (such as temperature, and shear schedule). Therefore, the concentration of the acid to increase the viscosity may change depending on the amount of materials and the conditions (temperature, pressure, etc.) of the subterranean formation.

### Example 2

### Lactic Acid

0.2 gpt (0.02% by volume) of a mixture of glutaraldehyde and water (1:3 ratio) was added to tap water. Next, 30 ppt (0.36 wt. %) of guar was then hydrated in the water. During the hydration, the fluid pH was controlled to be 6-8 using acetic acid. Once the hydration was completed, 0.5 gpt of a mixture of TMAC and water, 1 gpt of a surfactant, and 6 ppt of sodium bicarbonate were added while blending. A crosslinker solution was prepared by blending 0.6 gpt (relative to the whole volume of the fluid) of a mixture of 20% isopropanol and 80% triethanolamine titanate, 1.8 gpt (relative to the whole volume of the fluid) of a mixture of acetic acid, isopropanol and water, and five (5) different amounts of lactic acid (85% solution) ranging from 0 gpt, 0.05 gpt, 0.1 gpt, 0.2 gpt and 0.5 gpt (relative to the whole volume of the fluid). This resulted in the formation of five different fluids.

The viscosity (at a shear rate of 100/s) at 145° F. (63° C.) of the five (5) titanate-crosslinked gel fluids was measured with a Fann50-type viscometer. The viscosities for these fluids are shown in FIG. 2.

As shown in FIG. 2, compared with the baseline fluid (with 0 gpt lactic acid), the fluid with 0.1 gpt lactic acid (85%) showed an enhanced (over about 100%) viscosity and the fluid with 0.2 gpt lactic acid (85%) showed a slightly enhanced viscosity, as compared to the other fluids. However, the present inventors understand that the viscosity enhancing effect of the glycolic acid depends on a number of factors including, but not limited to, the fluid formula (such as polymer loading, and fluid chemical types and doses) and the test conditions (such as temperature, and shear schedule). This suggests that viscosity enhancement occurred at certain concentrations of the lactic acid.

### Example 3

### Carboxymethyl Cellulose and Lactic Acid

A crosslinked carboxymethyl cellulose (CMC) fluid was made with tap water, 0.5% KCl, and 40 ppt sodium carboxymethyl cellulose, or CMC), and crosslinked with 4 gpt of a solution containing a proprietary crosslinker containing Zr, B and Al and six (6) different concentrations of lactic acid (85% solution) (0 gpt, 0.1 gpt, 0.3 gpt, 0.5 gpt, 0.75 gpt and 1 gpt). The viscosity (at 100/s shear rate) at 225° F. (107° C.) of the crosslinked CMC fluid was measured with a Fann50-type viscometer.

The viscosity (at a shear rate of 100/s) at 225° F. (107° C.) of the six (5) Zr—B—Al-crosslinked gel fluids was measured with a Fann50-type viscometer. The viscosities for these fluids are shown in FIG. 3.

As shown in FIG. 3, the fluid with 0.1 gpt lactic acid showed a slightly larger viscosity compared to the baseline fluid, while the fluid with 0.5 gpt lactic acid (85%) showed a much larger viscosity than the baseline. At higher lactic acid doses, for example, the fluid with lgpt lactic acid (85%) showed a decreased viscosity compared to the baseline fluid. This example again suggests that viscosity enhancement occurred at certain concentration range of the lactic acid.

Although the preceding descriptions has been described herein with reference to particular means, materials and embodiments, it is not intended to be limited to the particular disclosed herein; rather, it extends to all functionally equivalent structures, methods and uses, such as are within the scope of the appended claims. Further, those skilled in the art will readily appreciate that many modifications are possible in the example embodiments without materially departing from VISCOSITY ENHANCEMENT OF POLYSACCHARIDE FLUIDS. Accordingly, all such modifications are intended to be included within the scope of this disclosure as defined in the following claims.

What is claimed is:

1. A method of treating a subterranean formation, the method comprising:
providing a treatment composition comprising at least one hydroxyl carboxylic acid, a crosslinkable component and a crosslinking agent; and
introducing the treatment composition to the subterranean formation, wherein the combination of the hydroxyl carboxylic acid, a crosslinkable component and a crosslinking agent increases the viscosity of the well treatment composition.

2. The method of claim 1, wherein the increased viscosity may be from about 100% to about 1000% when compared to a baseline viscosity.

3. The method of claim 1, wherein the increased viscosity may be from about 100% to about 300% when compared to a baseline viscosity.

4. The method of claim 1, wherein the at least one hydroxyl carboxylic acid is an α-hydroxy carboxylic acid, a β-hydroxy carboxylic acid and a γ-hydroxy carboxylic acid.

5. The method of claim 4, wherein the α-hydroxy carboxylic acid is a monocarboxylic acid.

6. The method of claim 4, wherein the α-hydroxy carboxylic acid is lactic acid or a glycolic acid.

7. The method of claim 1, wherein the at least one hydroxyl carboxylic acid is present in the treatment fluid in an amount of from about 0.05 gpt to about 1 gpt.

8. The method of claim 1, wherein the crosslinkable component is selected from the group consisting of guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2-methyl-propane sulfonic acid, acrylic acid, acrylamide, or derivative thereof and combinations thereof.

9. The method of claim 1, wherein the crosslinking agent is a polyvalent metal ion.

10. The method of claim 1, wherein the crosslinking agent is selected from the group consisting of zirconium IV, titanium, aluminum, boron and combinations thereof.

11. A method of treating a subterranean formation, the method comprising:
providing a treatment composition comprising at least one hydroxyl carboxylic acid, a crosslinkable component and a crosslinking agent; and
introducing the treatment composition to the subterranean formation, wherein the combination of the hydroxyl carboxylic acid, a crosslinkable component and a crosslinking agent increases the viscosity of the well treatment composition of from about 100% to about 500% when compared to a baseline viscosity.

12. The method of claim 11, wherein the at least one hydroxyl carboxylic acid is an α-hydroxy carboxylic acid, a β-hydroxy carboxylic acid and a γ-hydroxy carboxylic acid.

13. The method of claim 12, wherein the α-hydroxy carboxylic acid is a monocarboxylic acid.

14. The method of claim 12, wherein the α-hydroxy carboxylic acid is lactic acid or a glycolic acid.

15. The method of claim 11, wherein the at least one hydroxyl carboxylic acid is present in the treatment fluid in an amount of from about 0.05 gpt to about 1 gpt.

16. The method of claim 11, wherein the crosslinkable component is selected from the group consisting of guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2-methyl-propane sulfonic acid, acrylic acid, acrylamide, or derivative thereof and combinations thereof.

17. The method of claim 11, wherein the crosslinking agent is a polyvalent metal ion.

18. The method of claim 11, wherein the crosslinking agent is selected from the group consisting of zirconium IV, titanium, aluminum, boron and combinations thereof.
